(19) United States
(12) Patent Application Publication
(10) Pub. No.: US 2021/0158461 A1
(43) Pub. Date: May 27, 2021

(54) System and Method of Order Fulfillment to Nonexclusive Delivery Locations Using Customer Location Tracking

(71) Applicant: Daniel Nagy, Anaheim, CA (US)

(72) Inventor: Daniel Nagy, Anaheim, CA (US)

(21) Appl. No.: 16/695,181

(22) Filed: Nov. 26, 2019

(51) Int. Cl. G06Q 50/12; G06Q 10/08; H04W 4/029; H04W 4/021; G01S 19/51

(52) U.S. Cl. CPC G06Q 50/12; G06Q 10/083; G01S 19/51; H04W 4/021; H04W 4/029

(57) ABSTRACT

Systems, methods, and apparatus are disclosed that provide a pickup process for items purchased from a store. In some embodiments, a mobile computing device of a customer may determine whether the mobile computing device and therefore the customer are in an undesignated and/or nonexclusive pickup location within the vicinity of a store. In response to determining that the mobile computing device is in an undesignated and/or nonexclusive pickup location within the vicinity of a store, the mobile computing device may notify the customer and request whether the customer wishes to initiate pickup of purchased items from the store. The mobile computing device may notify a pickup system of the customer's desire to pick up the purchased items wherein the request causes the item to be delivered to the undesignated and/or nonexclusive pickup location.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### Field of the Invention

The invention relates to the field of order fulfillment and, more specifically, to services associated with picking-up ordered items.

### Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Customers commonly purchase food items and/or food services from various brick-and-mortar restaurants. When purchasing food items from such establishments, the customer then proceeds to a checkout lane where a sales associate scans or enters each item into a point of sale terminal in order to determine the total purchase price for the selected items. The sales associate collects payment from the customer and provides the customer with a sales receipt or another form showing proof of purchase for the selected and paid for items. After checking out via one of the provided checkout lanes, the customer is then free to leave the brick-and-mortar establishment with the purchased items.

A similar process is commonly used by customers that purchase food and/or services from various on-line storefronts of restaurants. When purchasing items from such establishments, a customer places such items in a virtual shopping cart. After placing items into their virtual shopping cart, the customer may then proceed with checkout which determines the total purchase price for the items selected by the customer, collects payment for the selected items, and arranges for delivery of such items to the customer. Commonly, delivery to the customer takes the form of shipping the food ordered to an address specified by the customer. Moreover, such shipping is commonly at the customer's expense.

The above conventional brick-and-mortar and on-line shopping processes may be effective. However, there is still room for improving such processes to provide unique shopping experiences and strengthen customer loyalty. None of the prior art methods have been found to be completely suitable to meet these needs and are cumbersome. The present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, and abstract as a whole.

Systems and methods directed to an order fulfillment process are substantially shown in and/or described in connection with at least one of the figures, and are set forth more completely in the claims.

Briefly, it is a principal object of the invention to provide Systems, methods, and apparatus that provide a pickup process for items purchased from a store. In some embodiments, a mobile computing device of a customer may determine whether the mobile computing device and therefore the customer are in an undesignated and/or nonexclusive pickup location within the vicinity of a store.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows an order fulfillment system in accordance with an example embodiment of the present invention.

FIG. 2 shows a simplified depiction of an example com-puting device for use in the system of FIG.1.

FIG. 3 shows a process implemented by an example embodiment of the e-commerce system of FIG. 1.

FIG. 4 shows a process implemented by an example embodiment of the mobile computing device of FIG. 1.

FIG. 5 shows a process implemented by an example embodiment of the food pickup system of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

Unless otherwise defined, all terms (including technical and scientific terms) used herein have the same meaning as commonly understood by one having an ordinary skill in the art to which the invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques are disclosed. Each of these has individual benefit and each can also be used in conjunction with one or more, or in some cases all, of the other disclosed techniques. Accordingly, for the sake of clarity, this description will refrain from repeating possible combination in an unnecessary fashion. Nevertheless, the specifications and claim/s should be read with the understanding that such combinations are entirely within the scope of the invention and the claims.

Some disclosed embodiments are directed to fulfillment of customer orders and, in particular, delivering and/or otherwise providing ordered food items to a customer. More specifically, some disclosed embodiments leverage mobile devices, such as cellular phones, smart phones, tablet devices, etc., that are commonly in the possession of customers to detect a customer's location. The detected customer location may be utilized by an order fulfillment process to assist in providing and/or otherwise delivering food or merchandise to the customer in a timely manner.

Various embodiments are described in the context of a customer ordering food from a restaurant and picking-up the ordered items from an undesignated and/or nonexclusive pickup location in a reasonable proximity to the restaurant. However, some aspects of the disclosed embodiments may also apply to other types of businesses such as virtual kitchens (kitchens that do not face consumers,) private kitchens, grocery stores, liquor stores, retail stores, pharmacies, dry cleaners, service centers, repair centers, e-commerce sites, shipping services, etc. Additionally, some aspects of the disclosed embodiments may also apply to other types of merchandise and/or services, such as groceries, consumable goods, retail goods, clothes, electronics, construction materials, shipping services, etc. Embodiments, for use in such contexts, are envisioned and protection for such embodiments is sought to the extent encompassed by the appended claims.

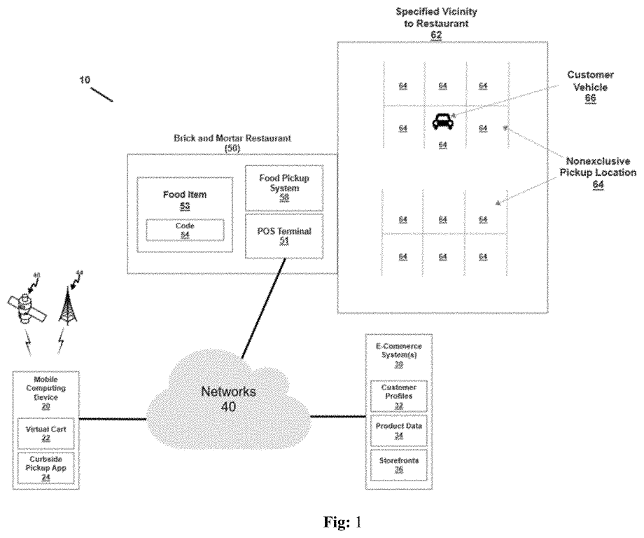

Today's consumers demand convenience, speed, and selection from their retailers regardless of whether such consumers are shopping online or are shopping in a brick and mortar establishment. The following describes various ways a mobile computing device such as a tablet, smart phone, mobile phone, personal data assistant, hand-held gaming console, or some other form of mobile computing device may be used to support delivery of purchased food items. To this end, a high-level system diagram of an order fulfillment system 10 is depicted in FIG. 1.

As shown, the order fulfillment system 10 may include a mobile computing device 20 connected to an e-commerce system 30 and food pickup (FPU) system 58 via one or more networks 40. The networks 40 may include a number of private and/or public networks such as, for example, wireless and/or wired LAN networks, cellular networks, and the Internet that collectively provide a communication path and/or paths between the mobile computing devices 20, e-commerce system 30, and FPU system 58. The mobile computing devices 20 may include tablets, smart phones, mobile phones, personal data assistants, hand-held gaming consoles, and/or other forms of mobile computing devices which enable a user to communicate with the e-commerce system 30 and/or FPU system 58 via the network 40. As shown, the mobile computing device 20 may further maintain a virtual shopping cart 22 in which a customer may place items for later purchase.

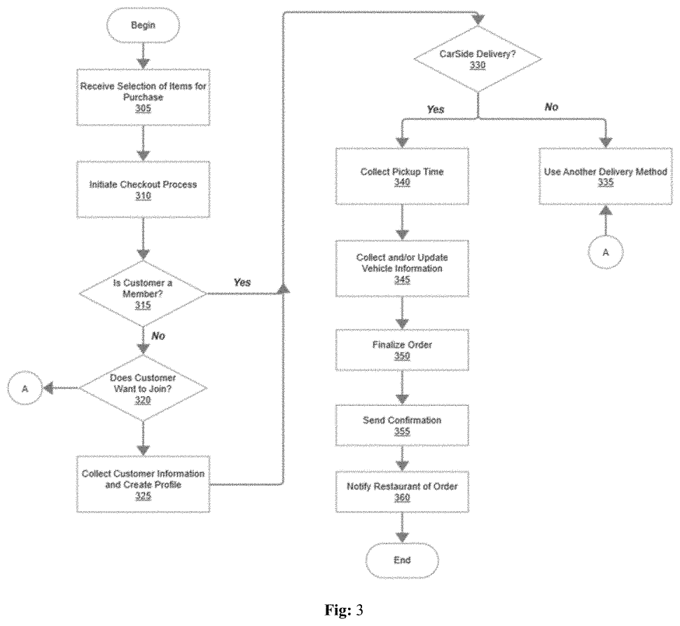

Moreover, the mobile computing device 20 may include a carside pickup application 24. The carside pickup application 24 comprises instructions that, in response to being executed by the mobile computing device 20, cause the mobile computing device 20 to perform various tasks associated with the processes described in detail below with respect to FIGS. 3-5. In some example embodiments, the mobile computing device 20 may download the carside pickup application 24 from various online application stores. Moreover, while depicted in FIG. 1 as a separate application, a larger application that provides additional functionality beyond supporting the processes of FIGS. 3-5 may include the carside pickup application 24.

The e-commerce system 30 may include one or more web servers, database servers, routers, load balancers, and/or other computing and/or networking devices. The e-commerce system 30 may maintain customer profiles 32 for various customers that utilize the shopping services provided by the order fulfillment system 10. Moreover, the e-commerce system 30 may maintain various information 34 regarding food or services 53 for sale by the brick-and-mortar restaurant 50. Furthermore, the e-commerce system 30 may provide one or more online storefronts 36 that permit customers to purchase items 53 using a computing device. In some embodiments, one or more of the storefronts 36 are publicly accessible via a public network such as the Internet thus permitting customers to purchase food items 53 from such storefronts 36 from the comfort of their homes or from other locations. In some embodiments, one or more of the store-fronts 36 are not publicly accessible and limited to only computing devices such as mobile devices outside of the restaurant 50 (e.g. private kitchens, virtual kitchens, and kitchens without direct consumer access.)

As shown, the brick-and-mortar restaurant 50 may include the point of sale (POS) terminals 51 and the FPU system 58. The FPU system 58 may include one or more web servers, database servers, routers, load balancers, and/or other computing and/or networking devices. In some embodiments, the FPU system 58 is integrated into the POS terminals 51. As explained in greater detail below with respect to the processes of FIGS. 3-5, the FPU system 58 may assist in the delivery of purchased items 53 to a customer's vehicle 66 positioned at an undesignated and/or nonexclusive carside pickup location 64 in a specified vicinity 62 near the restaurant 50. In some embodiments, the specified vicinity 62 near the restaurant include public parking areas that are not exclusive to the restaurant 50 such as public parking lots, private property parking lots, public street parking, private parking garages, public parking garages, etc. In some embodiments, the undesignated and/or nonexclusive carside pickup location 64 in a specified vicinity 62 to the restaurant 50 include public parking spots that are not exclusive to the restaurant 50 such as public property parking spots, private property parking spots, public street parking, public metered parking, short term curbside parking, unloading zones, public parking spots in a parking garage, etc.

FIG. 1 depicts the order fulfillment system 10 at a high level, the order fulfillment system 10, however, may be implemented in numerous different manners using a wide range of different computing devices, platforms, networks, etc. Moreover, aspects of the order fulfillment system 10 may be implemented using a client/server architecture, a peer-to-peer (P2P) architecture, and/or another networking architecture.

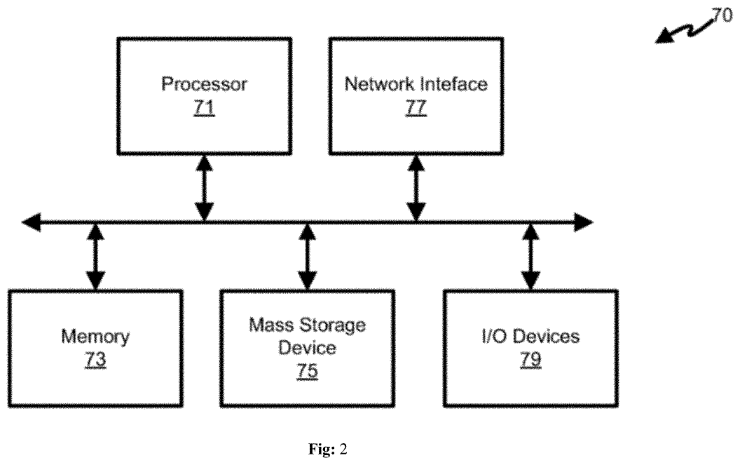

In some embodiments, the mobile computing device 20, the e-commerce system 30, POS terminals 51, and/or FPU system 58 may be implemented using various types of computing devices. FIG. 2 provides a simplified depiction of a computing device 70 suitable for such aspects of order fulfillment system 10. As shown, the computing device 70 may include a processor 71, a memory 73, a mass storage device 75, a network interface 77, and various input/output (I/0) devices 79. The processor 71 may be configured to execute instructions, manipulate data and generally control operation of other components of the computing device 70 as a result of its execution. To this end, he processor 71 may include a general-purpose processor such as an x86 processor or an ARM processor which are available from various vendors. However, the processor 71 may also be implemented using an application specific processor and/or other circuitry. The memory 73 may include various types of random-access memory (RAM) devices, read only memory (ROM) devices, flash memory devices, and/or other types of volatile or non-volatile memory devices. In particular, such memory devices of the memory 73 may store instructions and/or data to be executed and/or otherwise accessed by the processor 71. In some embodiments, the memory 73 may be completely and/or partially integrated with the processor 71.

In general, the mass storage device 75 may store software and/or firmware instructions which may be loaded in memory 73 and executed by processor 71. The mass storage device 75 may further store various types of data which the processor 71 may access, modify, and/otherwise manipulate in response to executing instructions from memory 73. To this end, the mass storage device 75 may comprise one or more redundant array of independent disks (RAID) devices, traditional hard disk drives (HDD), sold state device (SSD) drives, flash memory devices, read only memory (ROM) devices, and/or other types of non-volatile storage devices.

The network interface 77 may enable the computing device 70 to communicate with other computing devices via network 40. To this end, the networking interface 77 may include a wired networking interface such as an Ethernet (IEEE 802.3) interface, a wireless networking interface such as a Wi-Fi (IEEE 802.11) interface, a radio or mobile interface such as a cellular interface (GSM, CDMA, LTE, etc.) or near field communication (NFC) interface, and/or some other type of networking interface capable of provid-ing a communications link between the computing device 70 and network 40 and/or another computing device.

Finally, the I/0 devices 79 may generally provide devices which enable a user to interact with the computing device 70 by either receiving information from the computing device 70 and/or providing information to the computing device 70. 55 For example, the I/0 devices 79 may include display screens, keyboards, mice, touch screens, microphones, audio speakers, digital cameras, optical scanners, RF transceivers, etc.

While the above provides some general aspects of a computing device 70, those skilled in the art readily appreciate that there may be significant variation in actual implementations of a computing device. For example, a smart phone implementation of a computing device generally uses different components and may have a different architecture than a database server implementation of a computing device. However, despite such differences, computing devices generally include processors that execute software and/or firmware instructions in order to implement various functionality. As such, the above described aspects of the computing device 70 are not presented from a limiting standpoint but from a generally illustrative standpoint.

The present application envisions that aspects of the present application may find utility across a vast array of different computing devices and the intention is not to limit the scope of the present application to a specific computing device and/or computing platform beyond any such limits that may be found in the appended claims. In some embodiments, the mobile computing device 20 may include one or more I/0 devices 79 suitable for identifying an item 53 which the customer wishes to purchase. For example, the mobile computing device 20 may include 15 a digital image sensor (e.g., a digital camera), an optical scanner, an RF transceiver, a near field communication (NFC) transceiver, and/or some other device suitable for reading, scanning, and/or imaging codes 54 associated with items 53.

In such embodiments, the customer may select items 53 and place them in their virtual cart 22 by reading, scanning, imaging, etc. various codes 54 associated with the items 53. In particular, the mobile computing device 20 may support reading, scanning, and/or imaging a large variety of codes such as bar codes, Universal Product Codes (UPC) 25 codes, Quick Response (QR) codes, Augmented Reality (AR) codes, radio-frequency identification (RFID) tags, near field communication (NFC) codes. Moreover, such codes 54 may be attached to the item 53, to tags or labels that are attached to the item 53, and/or tags or labels that are 30 otherwise associated with the item 53. For example, such codes 54 may be placed upon display signs for the item 53, shelf tags for the item 53, or at some other locale associated with the item 54 so that the customer may readily scan, read, or image such codes 54 with the mobile computing device 20.

Besides using the mobile computing device 20 to select items 53 and place such items in a virtual cart 22, the customer may also use the mobile computing device 20 to purchase the items in their virtual cart 22. For example, the customer may enter credit card and/or other payment information via the mobile computing device 20. The mobile computing device 20 may transmit such information to the e-commerce system 30 which may verify payment information and provide the mobile computing device 20 with one or more proofs of purchase (e.g., a digital receipt, bar codes, etc.) for the items 53 in the virtual cart 22.

In some embodiments, the customer may choose a manner of fulfillment for each item in their virtual cart 22. In particular, the customer in one embodiment may choose whether a particular food item 53 is to be provided to the customer via carside pickup or shipped to the customer's address. In particular, the mobile computing device 20 may request the customer to choose a fulfillment option for each food item 53 as its placed in their virtual cart 22. Since such constant queries may become tedious to the customer, the mobile computing device 20 may assume a default fulfillment option (e.g., carside pickup) for each item 53 unless the customer indicates a different option for the item 53.

The mobile computing device 20 may further permit the customer to choose the default fulfillment option and/or permit the customer to set a fulfillment option for the complete order. In some embodiments, the mobile computing device 20 may permit the customer to review and revise 65 the fulfillment option for each item 53 in the virtual cart 22 as part of the checkout process.

In some embodiments, the I/O devices 79 of the mobile computing device 20 may include a geographic positioning system (GPS) receiver to permit the mobile computing device 20 to determine its global position. In particular, the GPS receiver may be configured to receive signals from GPS satellites 46 and ascertain the geographic position of the GPS receiver based on such received GPS satellite signals. In other embodiments, the I/O devices 79 of the mobile computing device 20 may not include a GPS receiver, but the mobile computing device 20 may be able to determine its position nonetheless. For example, as noted above, the network interface 77 may include a cellular interface (GSM, CDMA, LTE, etc.) Such a cellular interface may permit the mobile computing device 20 to receive signals from various cell towers 44. Based on known positions of the cell towers 44 and the signals received from such towers 44, the mobile computing device 20 may be able to discern its position (e.g., using triangulation).

As mentioned above, the order fulfillment system 10 may support or provide various features that attempt to enhance and/or otherwise improve a customer's shopping experience. To this end, the order fulfillment system 10 may provide carside pickup for purchased items. In particular, the order fulfillment system 10 may support carside pickup for items via an on-line storefront associated with the brick-and-mortar restaurant 50. As explained below, the order fulfillment system 10 may cause food items to be delivered to a customer's vehicle 66 in an undesignated and/or nonexclusive pickup location 64 without the customer entering the restaurant 50.

FIG. 3 shows a process 300 that may be implemented by an example embodiment of the e-commerce system 30. Per the process 300, the e-commerce system 30 may permit a customer to purchase food items 53 for carside pickup at a selected restaurant 50.

To this end, the e-commerce system 30 at 305 may receive a customer's selection of one or more foodcitems 53 for purchase. In particular, a customer may use a computing device 70 to interact with a storefront 36 of the e-commerce systems 30 and place food items 53 in a virtual shopping cart 22 maintained by the computing device 70 and/or the e-commerce system 50. The computing device 70 may be external to the restaurant 50 such as a mobile phone, a tablet, a laptop, a desktop, or another computing device capable of communicating with a storefront 36 that is accessible via a public network such as the Internet.

After the customer selects food items 53 for purchase, the e-commerce system 30 at 310 may initiate a checkout process in response to receiving an indication from the customer via a computing device 70 that the customer is ready to purchase the selected items 53 and finalize the purchase. During the checkout process, the e-commerce system 30 may confirm payment of the items 53 as well as confirm other information for delivering the purchased items 53 to the customer.

At block 315, the e-commerce system 30 may determine whether the customer is a member. As depicted, the e-commerce system 30 may make such determination after initiating the checkout process. In other embodiments, a member may manually and/or automatically login upon visiting the storefront 36. The e-commerce system 30, in such embodiments, may determine whether the customer is a registered member of the storefront 36 prior to initiating the checkout process. If the e-commerce system 30 at 315 determines the that the customer is not a registered member, then the e-commerce system 30 at 320 may ask the customer via the computing device 70 whether the customer would like to become a registered member. If the e-commerce system 30 receives a response indicating that the customer does not wish to become a member, then the e-commerce system 30 may proceed with an anonymous and/or guest checkout process at 335 which permits the customer to finalize the purchase without joining the storefront 36 or becoming a registered member.

Otherwise, the e-commerce system 30 may collect information from the customer via the computing device 70 and create a customer profile 32 based on the collected information. For example, the e-commerce system 30 may collect name, shipping address, billing address, payment information, email address, user name, password, and/or other information from which to establish the customer profile 32.

After determining the customer is a member at 315 or creating a profile 32 for the newly joined member at 325, the e-commerce system 30 at 330 may ask whether the purchased food items 53 are to be delivered via carside pickup. Such an inquiry may be part of a checkout process in which the customer selects a form of delivery for the entire order and/or individually selects a form of delivery for each purchased item 53. Moreover, in one embodiment, carside pickup is a service offered only to members and thus not presented to customers that elect to forgo membership. However, in other embodiments, the e-commerce system 30 may offer carside pickup to customers that are not registered members. If the customer does not select carside pickup for any of the purchased items 53, the e-commerce system 30 at 335 may proceed with finalizing the order using other delivering processes such as allowing the customer to pick up the food items 53 in the restaurant 50 or shipment to a shipping address of the customer profile 32.

Otherwise, the e-commerce system 30 at 340 collects information from the customer regarding a pickup time of the purchased food items. Some food items commonly require preparation time for cooking, baking, or similar preparation methods. The customer can request to have the purchased food items 53 prepared immediately and readied for carside pickup as soon as the food items 53 are prepared. The customer can also request for the purchased food items 53 to be prepared for carside pickup at a specified time later in the future.

The e-commerce system 30 then at 345 collects information from the customer regarding the vehicle 66 which will be used during the carside pickup. For example, the e-commerce system 30 via a computing device 70 may present the customer with a form that permits the customer to select a year, make, model, and color of the vehicle 66 to be used during the carside pickup. The form may further provide an option that permits the customer to save the vehicle information to the customer's profile 32. By saving vehicle information to the customer profile 32, the e-commerce system 30 during future purchases may present a form which permits the customer to select previously saved vehicle information and which permits the customer to add further vehicle information to the customer profile 32.

The e-commerce system 30 may then finalize the order at 350. For example, the e-commerce system 30 may verify that the restaurant 50 from which the customer wishes to pick up the purchased food items 53, verify availability of all purchased food items 53 from the selected restaurant 50, verify and/or execute payment for the purchased food items 53, verify billing address of the customer, etc. The e-commerce system 30 may provide the customer with instructions for picking-up the purchased items 53 from the selected store 50 as well as hyperlinks and/or other mechanisms for obtaining a copy a carside pickup application 24 for aiding the customer and store 50 with the carside pickup process. For example, in one embodiment, the e-commerce system 30 may inform the customer via computing device 70 that the purchased items 53 should be ready for pickup in less than 2 hours, but that the customer should wait for an email notifying the customer that the purchased items 53 are available for pickup before traveling to the store 50.

At 355, the e-commerce system 30 may provide the customer with one or more order confirmations. For example, the e-commerce system 30 may cause a web browser of the computing device 70 to display a receipt for the purchased items and provide a link or other mechanism via which the customer may download and/or print the receipt. The e-commerce system 30 may further email a receipt or an order confirmation to the customer using an email address supplied during the checkout process or pulled from the customer profile 32.

At 360, the e-commerce system 30 may notify the FPU system 58 for the selected restaurant 50 of the purchased items 53. Such notice permits one or more FPU associates of the restaurant 50 to prepare and/or gather the purchased food items 53 prior to the customer arriving at the restaurant 50. The FPU system 58 may use the pickup time specified by the customer via the mobile computing system 20 to notify one or more FPU associates of the restaurant 50 to prepare the purchased food items 53 at said pickup time. In another embodiment, the FPU system 58 may track the location of the mobile computing system 20 and/or carside pickup app 24 to calculate a more accurate estimated arrival time and adjust the preparation time of the purchased food items 53 for one or more FPU associates of the restaurant 50. Tracking the location of the customer may further help to coordinate the preparation of purchased food items 53 with the arrival time of the customer at the undesignated and/or nonexclusive carside pickup location 64. Moreover, as explained in more detail below, the restaurant 50 may notify the customer when the order is ready for pickup so that the customer may pick up the purchased items 53 without a lengthy wait at the restaurant 50.

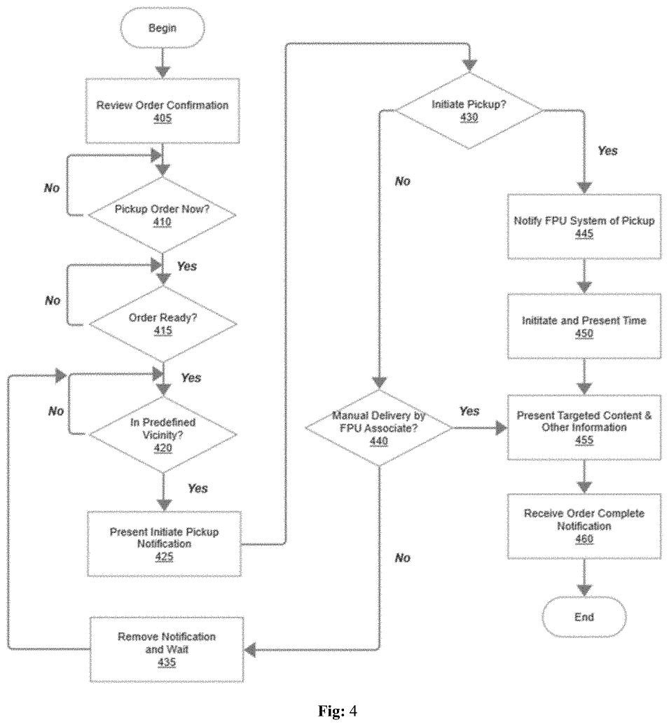

Referring now to FIG. 4, a process 400 that may be implemented by mobile computing device 20 and/or the carside pickup application 24 is shown. In the interest of clarity, the following process 400 is described from the standpoint of the carside pickup application 24 performing various actions. The carside pickup application 24 does not in fact perform such actions, but instead provides instructions which configure and/or otherwise cause the mobile computing device 20 to perform the respective actions due to execution of such instructions of the carside pickup application 24. Stating that software and/or firmware modules, such as the carside pickup application 24, perform various actions is merely a manner of convenience that is in common usage in the industry.

At 405, the mobile computing device 20 and/or the carside pickup application 24 may receive a message or other notification confirming the purchase of items 53. As noted above, the e-commerce system 30 at 355 may provide the customer with an order confirmation by, for example, sending an email using an email address associated with the customer. The mobile computing device 20 and/or the carside pickup application 24 at 405 may receive such order confirmation from the e-commerce system 30. In some embodiments, the notification may inform the carside pickup application 24 that an order ready notification is expected in the near future. As such, the carside pickup application 24 may alter its operation and/or the operation of the mobile computing device 20 in anticipation of the to-be-received notification that indicates the order is ready for pickup. For example, the carside pickup application 24 may adjust the frequency at which email is checked, adjust power management features, and/or adjust other operating characteristics associated with receiving the notification.

At 410 and 415, the carside pickup application 24 may determine whether a notification that the purchased food items 53 are ready for carside pickup has been received. In some embodiments, the FPU system 58 of the selected restaurant 50 may send a notification to the carside pickup application 24. For example, the FPU system 58 may use an address associated with the customer to send or otherwise provide an email message (e.g. Simple Mail Transfer Protocol (SMTP) message), a text message (e.g., a Short Message Service (SMS) message), a push notification (e.g., Apple Push Notification Message), an instant message (e.g., Extensible Messaging and Presence Protocol (XMPP) message), or some other form of message that the purchased items 53 of their order are ready for carside pickup at the selected store 50.

If the notification has yet to be received, the carside pickup application 24 continues to wait for the notification at 410 and/or 415. Otherwise, the carside pickup application 24 proceeds to 420 to determine whether the customer's mobile computing device 20 and therefore the customer is within a specified vicinity 62 of the restaurant 50. In particular, the carside pickup application 24 and/or the FPU system 58 may define the specified vicinity 62 using various techniques and distances. For example, the specified vicinity 62 may be defined using the geographic perimeter of the undesignated and/or nonexclusive private parking lot in the vicinity of the restaurant 50. The specified vicinity is a means to provide the restaurant 50 with a reasonable range for carside delivery but is not bound by any geographic limits.

The carside pickup application 24 uses global positioning capabilities of the mobile computing device 20 to determine the global position of the mobile computing device 20. The carside pickup application 24 may then compare the determined global position to a specified vicinity 62 of the restaurant 50 to determine whether the mobile computing device 20 is within the acceptable delivery range of the restaurant 50. Additionally, the carside pickup application 24 uses global positioning capabilities of the mobile computing device 20 to inform the FPU system 58 to a precise location of the customer's vehicle 66 positioned at an undesignated and/or nonexclusive carside pickup location 64 in a specified vicinity 62 near the restaurant 50.

If the carside pickup application 24 determines that the mobile computing device 20 is not within the specified vicinity 62 for the restaurant 50, then the carside pickup application 24 may continue to monitor the location of the mobile computing device 20 with respect to the specified vicinity 62 at 420. Otherwise, the carside pickup application 24 at 425 may generate a notification that requests whether the customer wants to initiate the carside pickup process.

The customer may be in the vicinity of the restaurant 50 for reasons other than picking-up the purchased food items 53. By requesting the customer whether to initiate the process, the customer does not feel obligated to pick up the food items 53 when not otherwise prepared. Moreover, FPU associates of the restaurant 50 do not waste time trying to deliver food items 53 to customers which were falsely identified as being in the specified vicinity 62 or who otherwise have no intention of picking-up the food items 53 at the present time. As such, the notification presented at 420 may be beneficial to both the customer and the restaurant 50.

If the customer at 430 is in a specified vicinity 62 near the restaurant 50 and elects to initiate the carside pickup process, the carside pickup application 24 at 445 may send a notification to the FPU system 58 that the customer intends to pick up the purchased food items 53, and that a FPU associate should gather the items 53 and be prepared to deliver such items 53 to the customer. The carside pickup application 24 may use an address associated with the FPU system 58 of the selected restaurant 50 to send or otherwise provide an email message, a text message, a push notification, an instant message, or some other form of notification that informs the FPU system 58 that the customer wishes to initiate carside pickup. Additionally, the carside pickup application 24 uses global positioning capabilities of the mobile computing device 20 to inform the FPU system 58 to the location of the customer's vehicle 66 positioned at a undesignated and/or nonexclusive carside pickup location 64 in a specified vicinity 62 near the restaurant 50.

In some embodiments, the FPU associates of the restaurant 50 may choose not to wait for the carside pickup application 24 to send a notification to the FPU system 58. At 440, if the FPU associates believe that the customer has arrived and parked in a undesignated and/or nonexclusive pickup location 64 with the intention of picking up the purchased food items 53, then the FPU associates may manually begin the carside pickup process of the purchased food items 53 to the customer. The FPU associate of the restaurant 50 may also deliver the purchased food items 53 to the customer in a undesignated and/or nonexclusive pickup location 64 without the notification from the carside pickup application 24.

The carside pickup application 24 at 450 may initiate and present the customer with a timer in response to initiating the carside pickup process at 430. In one embodiment, the carside pickup application 24 presents a timer which counts up and therefore represents the passage of time since initiating the carside pickup process at 430. In another embodiment, the carside pickup application 24 presents a timer which counts down from a guaranteed or targeted deliver time. In such an embodiment, the store 25 may have a policy of delivering the purchased items 53 to the customer's vehicle 66 within a specified period of time (e.g. 5 minutes) from initiating the carside pickup process at 430. The timer in such an embodiment therefore depicts the time remaining for delivery. In some embodiments, the store 50 may provide the customer with some form of compensation if the FPU associate is unable to deliver the purchased items 53 in the allotted time. For example, the store 50 may provide the customer with a coupon, store credit, a refund, partial refund, and/or some other form of compensation in an attempt to incentives customers to use their services.

The carside pickup application 24 at 455 may further provide the customer with content targeted at the customer, additional pickup instructions, and/or other information received from the FPU system 58 while the customer awaits delivery of the purchased food items 53 to their vehicle 66 located in an undesignated and/or nonexclusive carside pickup location 64 in a specified vicinity 62 near the restaurant 50. In some embodiments, the targeted content may include coupons, discounts, incentives to purchase items, videos, clips, audio, video, and/or textual messages, offers, sweepstake and/or other contest opportunities, social engagement options such as posting aspects of the order to social networking environments (e.g., community maintained by store 50, Twitter, Facebook, etc.). Moreover, the FPU system 58 may customize the targeted content based on the customers profile 32, purchased items 53 of the present order, and/or previously purchased items 53.

After receiving the food items 58 and finalizing the purchase, the carside pickup application 24 at 455 may receive and present a notification from the FPU system 58 confirming completion of the order. Such notification may include additional information regarding the order such as reward points earned as a result of the purchased food items 53 as well as applicable warranty information, rebates, and/or offers for related items 53.

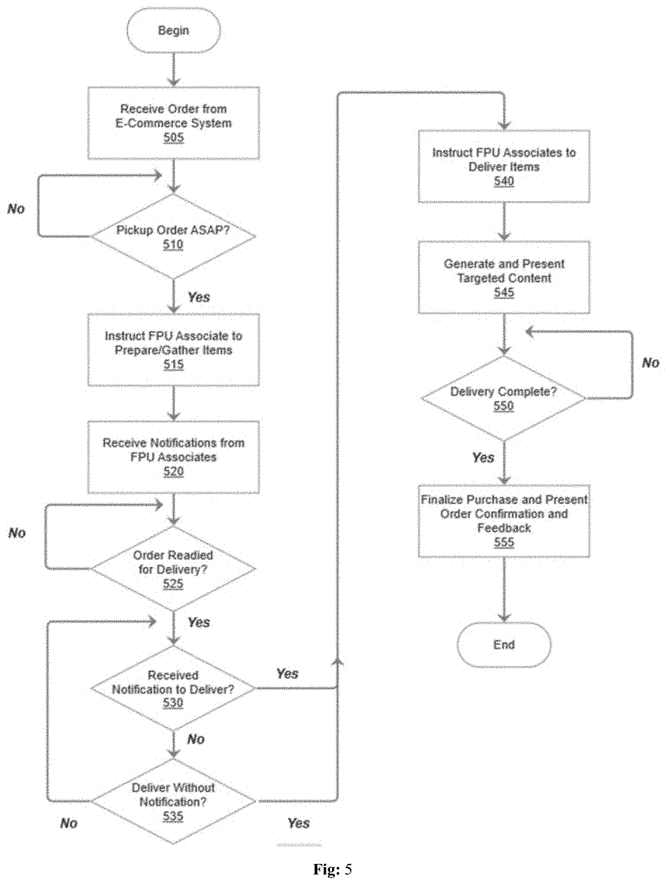

Referring now to FIG. 5, a process 500 that may be implemented by the FPU system 58 is shown. As noted above with respect to FIG. 3, the e-commerce system 30 at 360 may notify the restaurant 50 of the food items 53 purchased by the customer. At 505, the FPU system 58 may receive such notification from the e-commerce system 30.

In response to such notification, the FPU system 58 at 515 may instruct one or more FPU associates to ready the purchased items 53 for carside pickup. The FPU system 58 at 510 may determine if the items are to be prepared immediately or at a later time as indicated by the customer at 340, and may instruct the FPU associate whether to prepare the purchased food items 53 accordingly. In one embodiment, each FPU associate has a computing device 70 such as a tablet, smart-phone, or other portable computing device. The FPU system 58 may therefore instruct one or more FPU associates via their respective computing devices 70 to gather the purchased items 53 and ready them for carside delivery. In particular, the FPU associates may gather the purchased items 53 and place the gathered items 53 in designated areas, lockers, bins, etc. located near a carside pickup location 64 of the store 50. Such gathering and storing in designated areas, lockers, bins, etc. may enable quick retrieval of the items 53 once the customer's vehicle 66 arrives at the undesignated and/or nonexclusive carside pickup location 64. At 515, the FPU system 58 may receive notifications from the FPU associates via their respective computing devices 70 that the items 58 for the order have been gathered and readied for carside delivery.

The FPU system 58 at 525 may determine, based on notifications received from the FPU associates, whether all items 58 of the order are ready for carside pickup. If one or more food items 53 are not yet ready, the FPU system 58 may return to 520 to receive additional notifications from the FPU associates.

Otherwise, the FPU system 58 may notify the customer that the items 53 of their order are ready for carside pickup. As explained above with respect to 415 of FIG. 4, the FPU system 58 may use an address associated with the customer to send or otherwise provide an email message, a text message, a push notification, an instant message, or some other form of notification that informs the carside pickup application 24 of the customer's mobile computing device 20 that the purchased items 53 of their order are ready for carside pickup at the selected restaurant 50.

As noted above with respect to 425 of FIG. 3, the carside pickup application 24 may send or otherwise provide the FPU system 58 with an email message, a text message, a push notification, an instant message, or some other form of notification that informs the FPU system 58 that the customer wishes to initiate carside pickup. Accordingly, the FPU system at 530 may determine whether a notification to initiate carside pickup for a readied order has been received from a carside pickup application 24.

If the FPU system 58 determines that such a notification has not been received, then the FPU system 58 may wait at 530 until such a notification is received. In response to determining that such a notification has been received, the FPU system 58 at 540 may notify one or more FPU associates via respective computing devices 70 to deliver the items 53 to the customer. In one embodiment, the FPU system 58 may provide such notification via an email message, a text message, a push notification, an instant message, or some other form of notification that instructs the FPU associate to deliver the items 53 to the customer's vehicle 66 at a undesignated and/or nonexclusive carside pickup location 64. In particular, such notification may identify the food items 53 to be delivered, the requested pickup time of delivery, a location (e.g., designated area, locker, bins, etc.) from which the food items 53 may be retrieved, a undesignated and/or nonexclusive carside pickup location 64 to which the items 53 are to be delivered, as well as a description of the customer's vehicle 66 to which the food items 53 are to be delivered.

As explained above with respect to 440, the FPU system 58 and the FPU associates at 535 may elect to deliver the purchased food items 53 without receipt of the notification to initiate carside pickup from the carside pickup application 24. In one embodiment, the FPU associate may manually retrieve instructions from the FPU system 58 to deliver the items 53 to the customer's vehicle 66 at a undesignated and/or nonexclusive carside pickup location 64. In particular, such instructions may identify the food items 53 to be delivered, the requested pickup time of delivery, a location (e.g., designated area, locker, bins, etc.) from which the food items 53 may be retrieved, a undesignated and/or nonexclusive carside pickup location 64 to which the items 53 are to be delivered, as well as a description of the customer's vehicle 66 to which the food items 53 are to be delivered.

While the FPU associates deliver the food items 53 to the undesignated and/or nonexclusive carside pickup location 64, the FPU system 58 at 545 may provide targeted content to the customer via the carside pickup application 24. As noted above with respect to 455, the targeted information may include coupons, discounts, incentives to purchase items, videos, clips, audio, video, and/or textual messages, offers, sweepstake and/or other contest opportunities, social engagement options such as posting aspects of the order to social networking environments (e.g., community maintained by restaurant 50, Twitter, Facebook, etc.). Moreover, the FPU system 58 may customize the targeted content based on the customers profile 32, purchased items 53 of the present order, and/or previously purchased food items 53.

At 550, the FPU system 58 may determine whether the items 58 have been delivered to the undesignated and/or nonexclusive carside location 64. In one embodiment, the FPU associates verify the identity of the customer prior to handing the food items 53 over to the customer and/or loading the items 53 in the customer's vehicle 66. To this end, the FPU associates confirm that the vehicle 66 matches the description of the vehicle provided by the FPU system 58 via their computing devices 70. Moreover, the FPU associates may swipe and/or verify the credit card or debit card used by the customer to purchase the food items 53. The computing device 70 may verify whether the swiped card matches the card used to purchase the food items 53. The FPU associates may further require that the customer provide a picture identification card such as a driver's license and verify that the name on the identification card matches the name on the ordered items and that the picture on the identification card matches the customer.

In response to this verification process, the FPU system 58 may receive one or more confirmations and/or other messages from the FPU associates and determine at 505 whether delivery of the food items 53 to the carside pickup location 64 has been completed.

In response to determining that delivery has been completed, the FPU system 58 at 555 may finalize the purchase and notify the customer that the purchase is complete. In particulars, the FPU system 58 may finally submit the customer's credit card information to a card processing service for reimbursement. Moreover, the FPU system 58 may send the carside pickup application 24 of the customer a notification confirming completion of the order. Such notification may include additional information regarding the order such as reward points earned as a result of the purchased items 53 as well as applicable rebates and/or offers for related food items 53.

The processes of FIGS. 3-5 were described above with respect to a customer picking-up items at a undesignated and/or nonexclusive carside location 64. Aspects of such process, however, may be generally applicable to picking-up items from a store. In particular, aspects of the above process may be suitable for use in a system where items are not picked up from a carside location external to the restaurant 50 but instead are picked up from a pickup location, food service counter, or other location within the restaurant 50. The processes of FIGS. 3-5 were mainly described from the perspective of completely delivering food items 53 to a customer at a undesignated and/or nonexclusive carside location 64.

Despite a customer requesting pickup and having a vehicle 66 at the undesignated and/or nonexclusive pickup location 64, situations may still arise where delivering items 53 is not feasible. For example, one or more items 53 may not fit in the customer's vehicle 66 due to the customer underestimating the size of a large food item 53 (e.g., large catering containers) or the overall size of the ordered food items 53. The customer may, therefore, need to return with a larger vehicle 66 or pick up the items 53 across multiple trips. In such situations, the carside pickup application 24 and/or a computing device 60 of an FPU associate may permit a partial delivery and mark remaining items 53 for another pickup.

In some embodiments, the customer may purchase one or more items 53 that are not currently in stock at the store 50. As the items arrive at the store 50, the FPU system 58 may inform the carside pickup application 24 of the arrived items 53. The customer may then elect to carside pickup the available items 53 in a manner similar to the processes depicted in FIGS. 3-5 or elect to wait until all items have arrived. Regardless, the FPU system 58 may reserve such items 53 until at least all items of the order have arrived. In this manner, the customer may accept partial delivery of certain items 53 via carside pickup without necessarily awaiting the arrival of all items.

Various embodiments of the invention have been described herein by way of example and not by way of limitation in the accompanying figures. For clarity of illustration, exemplary elements illustrated in the figures may not necessarily be drawn to scale. In this regard, for example, the dimensions of some of the elements may be exaggerated relative to other elements to provide clarity. Furthermore, where considered appropriate, reference labels have been repeated among the figures to indicate corresponding or analogous elements. Moreover, certain embodiments may be implemented as a plurality of instructions on a tangible, computer readable storage medium such as, for example, flash memory devices, hard disk devices, compact disc media, DVD media, EEPROMs, etc. Such instructions, when executed by one or more computing devices, may result in the one or more computing devices performing various aspects of the pro-cesses depicted in FIGS. 3-5.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method, comprising:
a. after receiving an order confirmation for a food item, increasing, via one or more processors of a mobile computing device, a frequency of checking for an indication that the item should be prepared in response to a request for pickup at a specified time;
b. receiving via one or more processors of a mobile computing device, a frequency of checking for an indication that the item is ready for pickup;
c. receiving, via one or more processors of the mobile computing device, an indication that the item is ready for pickup; determining a current location of the mobile computing device via a satellite-based location determining system, wherein the mobile computing device comprises a GPS receiver, a display, a processor, and a wireless communication transceiver coupled to the GPS receiver;
d. in response to said receiving, determining, via one or more processors of the mobile computing device, whether the current location of the mobile computing device corresponds to a predefined vicinity to the restaurant for the item;
e. in response to determining that the current location of the mobile computing device corresponds to the predefined vicinity to the restaurant, generating and presenting, via one or more processors of the mobile computing device, a notification to a user of the mobile computing device that requests whether the user desires to initiate pickup of the item;
f. in response to determining that the mobile computing device has exited the predefined vicinity to the restaurant, waiting until the current location of the mobile computing device corresponds again to the predefined vicinity to the restaurant before presenting the notification again to the user of the mobile computing device; and
g. transmitting a request, via one or more processors of the mobile computing device, to initiate pickup of the item in response to the notification if the user desires to initiate pickup of the item, wherein the request causes the item to be delivered to the undesignated and/or nonexclusive pickup location.

2. The method of claim 1, further comprising: initiating a timer that reflects an elapse of time since initiating pickup; and presenting the timer via the mobile computing device.

3. The method of claim 1, further comprising: receiving content targeted to a customer associated with the item for pickup in response to said requesting pickup; and presenting the targeted content via the mobile computing device.

4. The method of claim 1, further comprising: receiving pickup instructions in response to said requesting pickup; and presenting the instructions via the mobile computing device.

5. The method of claim 1, wherein determining whether the current location of the mobile computing device corresponds to the predefined vicinity to the restaurant, comprises:
a. monitoring, with the mobile computing device, a global location of the mobile computing device;
b. comparing, with the mobile computing device, the global location of the mobile computing device to the predefined vicinity to the restaurant; and
c. determining, with the mobile computing device, a global location of the mobile computing device in the undesignated and/or nonexclusive pickup location.

6. A non-transitory computer readable storage device comprising a plurality of instructions, that in response to being executed, cause a mobile computing device to:
a. after receiving an order confirmation for an item, increase, via one or more processors of the mobile computing device, a frequency of checking for an indication that the item should be prepared in response to a request for pickup at a specified time,
b. after receiving an order confirmation for an item, increase, via one or more processors of the mobile computing device, a frequency of checking for an indication that the item is ready for pickup;
c. determine a current location of the mobile computing device via a satellite-based location determining system, wherein the mobile computing device comprises a GPS receiver, a display, a processor, and a wireless communication transceiver coupled to the GPS receiver
d. determine, in response to receiving an indication that an item is ready for pickup, whether the current location of the mobile computing device corresponds to a predefined vicinity to the restaurant;
e. in response to determining that the current location of the mobile computing device corresponds to the predefined vicinity to the restaurant, generate and present, via one or more processors of the mobile computing device, a notification to a user of the mobile computing device that requests whether the user desires to initiate pickup of the item;
f. in response to determining that the mobile computing device has exited the predefined vicinity to the restaurant, wait until the current location of the mobile computing device corresponds again to the predefined vicinity to the restaurant before presenting the notification again to the user of the mobile computing device;
g. in response to determining that the current location of the mobile computing device corresponds to an undesignated and/or nonexclusive pickup location in the predefined vicinity to the restaurant, generate and present, via one or more processors of the mobile computing device, a notification to a user of the mobile computing device that requests whether the user desires to initiate pickup of the item; and
h. request, via one or more processors of the mobile computing device, pickup of the item in response to the notification if the user desires to initiate pickup, wherein the request causes the item to be delivered to the undesignated and/or nonexclusive pickup location.

7. The computer readable storage device of claim 6, wherein the plurality of instructions further causes the mobile computing device to initiate and present a timer that reflects an elapse of time since the request to pick up.

8. The computer readable storage device of claim 6, wherein the plurality of instructions further causes the mobile computing device to present content targeted to a customer associated with the item for pickup and received in response to requesting pickup.

9. The computer readable storage device of claim 6, wherein the plurality of instructions further causes the mobile computing device to present pickup instructions received in response to requesting pickup.

10. The computer readable storage device of claim 6, wherein the plurality of instructions further causes the mobile computing device to monitor a global location of the mobile computing device, and compare the global location to the defined vicinity to the restaurant.

11. The computer readable storage device of claim 6, wherein the plurality of instructions further causes the mobile computing device to monitor a global location of the mobile computing device, and determine the undesignated and/or nonexclusive pickup location.

12. The computer readable storage device of claim 6, wherein the plurality of instructions further causes the food pickup system to instruct the restaurant associate to deliver one or more items to an undesignated and/or nonexclusive pickup location when the mobile computing device is in an undesignated and/or nonexclusive pickup location and a notification to initiate pickup is not received from the mobile computing device.

13. A system, comprising: a computing device executing an application that configures the mobile computing device to:
a. after receiving an order confirmation for an item, increasing, via one or more processors of the mobile computing device, a frequency of checking for an indication that the item should be prepared in response to a request for pickup at a specified time,
b. increasing, via one or more processors of the mobile computing device a frequency of checking for an indication that the item is ready for pickup,
c. determine a current location of the mobile computing device via a satellite-based location determining system, wherein the mobile computing device comprises a GPS receiver, a display, a processor, and a wireless communication transceiver coupled to the GPS receiver,
d. request, in response to a notification that the mobile computing device is at a predefined vicinity to the restaurant, whether the user of the mobile computing device desires to initiate pickup of one or more items of an order; and
e. request, in response to a notification that the mobile computing device is at an undesignated and/or nonexclusive pickup location, whether the user of the mobile computing device desires to initiate pickup of one or more items of an order, wherein a confirmation by the user of the mobile device causes the item to be delivered to the undesignated and/or nonexclusive pickup location.

14. The system of claim 13, wherein
a. further comprising an e-commerce system configured to receive the order for the one or more items, and
b. notify a food pickup system of the order in response to receiving a request to initiate pickup of the one or more items.

15. The system of claim 13, wherein
a. further comprising an e-commerce system configured to receive a pickup time/date for the one or more items, and
b. notify a food pickup system of the order in response to receiving a request to for the pickup of the one or more items at said pickup time/date
c. the food pickup system is configured to instruct the associate to deliver the one or more items at such pickup time/date.

16. The system of claim 13, wherein:
a. the e-commerce system is further configured to obtain vehicle information that describes a vehicle to be used to pick up the one or more items; and
b. the food pickup system is configured to instruct the associate to deliver the one or more items to the described vehicle.

17. The system of claim 13, wherein: the e-commerce system is further configured to send to the application of the mobile computing device an order confirmation that indicates the order includes one or more items for pickup;

18. The system of claim 13, wherein a food pickup system is configured to provide the application of the mobile computing device with content targeted to a customer associated with the order in response to receiving the request from the mobile computing device.

19. The system of claim 13, wherein a food pickup system is configured to provide the application of the mobile computing device with pickup instructions in response to receiving the request from the mobile computing device.

20. The system of claim 13, wherein a food pickup system is configured to instruct the restaurant associate to deliver one or more items to an undesignated and/or nonexclusive pickup location when the mobile computing device is in an undesignated and/or nonexclusive pickup location and a notification to initiate pickup is not received from the mobile computing device.
